(19) United States
(12) Patent Application Publication
(10) Pub. No.: US 2015/0152271 A1
(43) Pub. Date: Jun. 4, 2015

(54) Composition For Surface Treatment, Method Of Preparing A Surface-Treated Article, And Surface-Treated Article

(71) Applicant: Dow Corning Corporation, Midland, MI (US)

(72) Inventors: Michael L. Bradford, Midland, MI (US); Hyun Daesup, Kyunggido (KR); Ryan Frederick Schneider, Midland, MI (US)

(73) Assignee: Dow Corning Corporation, Midland, MI (US)

(21) Appl. No.: 14/405,806

(22) PCT Filed: Jul. 10, 2013
(86) PCT No.: PCT/US13/49924

§ 371 Date: Dec. 5, 2014

Related U.S. Application Data
(60) Provisional application No. 61/670,958, filed on Jul. 12, 2012.

(51) Int. Cl. C09D 5/16

(52) U.S. Cl. CPC C09D 5/1687; C09D 5/1662

(57) ABSTRACT

A composition for surface treatment comprises a polyfluoropolyether silane, a solvent, and an additive compound for improving appearance and durability of layers formed from the composition. The layers formed from the surface treatment composition have excellent physical properties, including smudge and stain resistance, as well as durability.

### FIELD OF THE INVENTION

The present invention generally relates to a composition for surface treatment and, more specifically, to a composition for forming layers having excellent physical properties, a method of preparing a surface-treated article with the composition, and a surface-treated article formed therefrom.

### DESCRIPTION OF THE RELATED ART

Surfaces of electronic and optical devices/components are susceptible to staining and smudging, oftentimes due to oils from hands and fingers. For example, electronic devices including an interactive touch-screen display, e.g. smart phones, are generally smudged with fingerprints, skin oil, sweat, cosmetics, etc., when used. Once these stains and/or smudges adhere to the surfaces of these devices, the stains and/or smudges are not easily removed. Moreover, such stains and/or smudges decrease the usability of these devices.

In an attempt to minimize the appearance and prevalence of such stains and smudges, conventional surface treatment compositions have been applied on the surfaces of various devices/components to form conventional layers. However, once applied on the surfaces of these devices/components, conventional surface treatment compositions often leave an undesirable and uneven appearance. For example, conventional layers formed from conventional surface treatment compositions generally include undesirable streaks. Accordingly, the surfaces of such devices/components are generally rinsed after application of conventional surface treatment compositions, thus requiring additional processing steps, cost, and time, while decreasing durability of the conventional layers due to the additional step of rinsing the conventional layers.

### SUMMARY OF THE INVENTION AND ADVANTAGES

The present invention provides a composition for surface treatment. The composition comprises a polyfluoropolyether silane, a solvent, and an additive compound. The additive compound is selected from a silane compound and a silyl amine compound. The silane compound has the following general formula:

RₐSiX₄₋ₐ;

wherein each R is independently selected from a substituted or unsubstituted hydrocarbyl group and a nitrogen-containing substituent, with at least one R being a nitrogen-containing substituent, X is an independently selected hydrolysable group, and 1≦a<4.

The present invention also provides a method of preparing a surface-treated article. The method comprises applying the surface treatment composition on a surface of an article to form a layer on the surface of the article from the composition.

Further, the present invention provides a surface-treated article formed in accordance with the method.

The composition forms layers having excellent physical properties, including stain and smudge resistance, as well as excellent durability. As such, the layers formed from the composition have an extended useful life in which the layers have such desirable physical properties as compared to conventional layers formed from conventional compositions.

### DETAILED DESCRIPTION OF THE INVENTION

The present invention provides a composition for surface treatment, a method of preparing a surface-treated article, and a surface-treated article formed in accordance with the method. The composition forms layers having excellent physical properties, including smudge and stain resistance, as well as durability.

The composition comprises a polyfluoropolyether silane. In certain embodiments, the polyfluoropolyether silane of the composition has the following general formula (A): Y—Z_{a′}-[(OC₃F₆)_{b}—(OCF(CF₃)CF₂)_{c}—(OCF₂CF(CF₃))_{d}—(OC₂F₄)ₑ—(CF(CF₃))_{f}—(OCF₂)_{g}]—(CH₂)ₕ—X′—(CₙH₂ₙ)—((SiR₂—O)ₘ—SiR¹₂)ᵢ—(CⱼH₂ⱼ)—Si—(X″)_{3-z}(R²)_{z}. While the polyfluoropolyether silane of the composition is not limited to that of general formula (A), specific aspects of general formula (A) are described in greater detail below. The groups represented by subscripts b-g, i.e., the groups within the square brackets in formula (A), may be present in any order within the polyfluoropolyether silane, including a different order as that which is represented in general formula (A) above and throughout this disclosure. Moreover, these groups may be present in randomized or block form. In addition, the group represented by subscript b is typically linear, i.e., the group represented by subscript b may alternatively be written as (O—CF₂—CF₂—CF₂)_{b}. In the description below, Cₚ-C_{q} (with p and q each being integers) regarding a hydrocarbon or alkyl group means such group has from p to q carbon atoms.

In general formula (A) above, Z is independently selected from —(CF₂)—, —(CF(CF₃)CF₂O)—, —(CF₂CF(CF₃)O)—, —(CF(CF₃)O)—, —(CF(CF₃)—CF₂)—, —(CF₂—CF(CF₃))—, and —(CF(CF₃))—. Z is typically selected such that the polyfluoropolyether silane does not include an oxygen-oxygen (O—O) bond within the backbone. In addition, in this general formula, a′ is an integer from 1 to 200; b, c, d, e, f, and g are integers each independently selected from 0 or from 1 to 200; h, n and j are integers each independently selected from 0 or from 1 to 20; i and m are integers each independently selected from 0 or from 1 to 5; X′ is a divalent organic group or an oxygen atom; R¹ is an independently selected C₁-C₂₂ hydrocarbon group; z is an integer independently selected from 0 to 2; X″ is an independently selected hydrolysable group; R² is an independently selected C₁-C₂₂ hydrocarbon group which is free of aliphatic unsaturation; and Y is selected from F and Si—(X″)_{3-z}(R²)_{z}(CⱼH₂ⱼ)—((SiR¹₂—O)ₘ—SiR¹₂)ᵢ—(CₙH₂ₙ)—X′—(CH₂)ₕ—; wherein X″, X′, z, R², R¹, j, m, i, n and h are as defined above.

R¹, which is an independently selected C₁-C₂₂ hydrocarbon group, may be linear, branched, or cyclic. In addition, R¹ may include heteroatoms within the hydrocarbon group, such as oxygen, nitrogen, sulfur, etc., and may be substituted or unsubstituted. Typically, R¹ is C₁-C₄ alkyl group. In addition, the groups represented by subscripts n and j, i.e., groups (CₙH₂ₙ) and (CⱼH₂ⱼ), may also be independently linear or branched. For example, when n is 3, these groups may independently have the structure CH₂—CH₂—CH₂, —CH(CH₃)—CH₂, or —CH₂—CH(CH₃), wherein the latter two structures have pendent alkyl groups, i.e., these structures are branched and not linear.

With respect to the moieties represented by subscripts m, i and j: when subscript i is 0, subscript j is also 0; when subscript i is an integer greater than 0, subscript j is also an integer greater than 0; and when subscript i is an integer greater than 0, m is also an integer greater than 0. Said differently, when the group represented by subscript i is present, the group represented by subscript j is also present. The inverse is also true, i.e., when the group represented by subscript i is not present, the group represented by subscript j is also not present. In addition, when i is an integer greater than 0, the group represented by subscript m is present, and m is also an integer greater than 0. In certain embodiments, subscripts m and i are each 1. Typically, the subscript i does not exceed 1, although the subscript m may be an integer greater than 1 such that siloxane bonds (i.e., Si—O bonds) are present within the group represented by subscript i.

The polyfluoropolyether silane of the composition is subject to the proviso that when Y is F; Z is (CF₂)—; a′ is an integer from 1 to 3; and subscripts c, d, f and i are 0.

The hydrolysable group represented by X″ in general formula (A) is independently selected from a halide group, an alkoxy (—OR³) group, an alkylamino (—NHR³ or NR³R⁴) group, a carboxy (—OOC—R³) group, an alkyliminoxy (—O—N═CR³R⁴) group, an alkenyloxy (O—C(═CR³R⁴)R⁵) group, or an N-alkylamido (—NR³COR⁴) group, wherein R³, R⁴ and R⁵ are each independently selected from H and a C₁-C₂₂ hydrocarbon group. When R³, R⁴ and R⁵ are independently C₁-C₂₂ hydrocarbon groups, R³, R⁴ and R⁵ may be linear, branched, or cyclic. In addition, R³, R⁴ and R⁵ may independently include heteroatoms within the hydrocarbon group, and may be substituted or unsubstituted. Typically, R³, R⁴ and R⁵ are each independently selected C₁-C₄ alkyl groups. In certain embodiments, the hydrolysable group represented by X″ in general formula (A) is independently selected from an alkoxy (—OR³) group and an alkylamino (—NHR³ or NR³R⁴) group. When the hydrolysable group represented by X″ in general formula (A) is an alkylamino group, R³ and R⁴ optionally can form a cyclic amine in the alkylamino group

Non-limiting, exemplary embodiments of particular species of the polyfluoropolyether silane of the composition are described in detail below. Typically in these embodiments, z is 0 such that polyfluoropolyether silane includes three hydrolysable groups represented by X″. However, as described above, z can be an integer other than 0 (e.g. 1 or 2) such that these particular polyfluoropolyether silanes include fewer than three hydrolysable groups.

In certain embodiments, Y in general formula (A) is F. Typically, when Y in general formula (A) is F, subscripts c, d and g in general formula (A) are 0. As such, in these embodiments, when the groups represented by subscripts c, d and g are absent, the polyfluoropolyether silane has the general formula Y—Z_{a′}[(OC₃F₆)_{b}—(OC₂F₄)ₑ—(CF(CF₃))_{f}]—(CH₂)ₕ—X′—(CₙH₂ₙ)—((SiR¹₂—O)ₘ—SiR¹₂)ᵢ—(CⱼH₂ⱼ)—Si—(X″)_{3-z}(R²)_{z}.

In one embodiment of the composition in which Y in general formula (A) is F, as introduced above, Z in general formula (A) is —(CF₂)—, subscripts c, d, f and g in general formula (A) are 0 and subscripts b, e, h and n in general formula (A) are each independently an integer greater than 0. As but one example of this embodiment, subscript a′ is 3, subscript b is at least 1, subscript e is 1, subscript h is 1, X′ is an oxygen atom, subscript n is 3, and subscripts m, i and j are each 0. In this one example, the polyfluoropolyether silane has the following general formula: CF₃—CF₂—CF₂—(O—CF₂—CF₂—CF₂)_{b}—O—CF₂—CF₂—CH₂—O—CH₂—CH₂—CH₂—Si—(X″)_{3-z}(R²)_{z}. Thus, when the hydrolysable groups represented by X″ are all alkoxy groups, e.g. methoxy groups, this particular polyfluoropolyether silane has the following general formula: CF₃—CF₂—CF₂—(O—CF₂—CF₂—CF₂)_{b}—O—CF₂—CF₂—CH₂—O—CH₂—CH₂—CH₂—Si—(OCH₃)₃. Alternatively, when the hydrolysable groups represented by X″ are all alkylamino groups, e.g. N(CH₃)₂ groups, this particular polyfluoropolyether silane has the following general formula: CF₃—CF₂—CF₂—(O—CF₂—CF₂—CF₂)_{b}—O—CF₂—CF₂—CH₂—O—CH₂—CH₂—CH₂—Si—(N(CH₃)₂)₃. In these embodiments, subscript b is typically an independently selected integer from 17 to 25.

In another embodiment of the surface treatment composition in which Y in general formula (A) is F and Z in general formula (A) is —(CF₂)—, as described above, subscripts c, d, f and g in general formula (A) are 0 and subscripts b, e, h, n, m, i and j in general formula (A) are each independently an integer greater than 0. As but one example of this embodiment, subscript a′ is 3, subscript b is at least 1, subscript e is 1, subscript h is 1, X′ is an oxygen atom, subscript n is 3, subscript m and i are each 1, and subscript j is 2. In this one example, the polyfluoropolyether silane has the following general formula: CF₃—CF₂—CF₂—(O—CF₂—CF₂—CF₂)_{b}—O—CF₂—CF₂—CH₂—O—CH₂—CH₂—CH₂—Si(CH₃)₂—O—Si(CH₃)₂—CH₂—CH₂—Si—(X″)_{3-z}(R²)_{z}. Thus, when the hydrolysable groups represented by X″ are all alkoxy groups, e.g. methoxy groups, and z is 0, this particular polyfluoropolyether silane has the following general formula: CF₃—CF₂—CF₂—(O—CF₂—CF₂—CF₂)_{b}—O—CF₂—CF₂—CH₂—O—CH₂—CH₂—CH₂—Si(CH₃)₂—O—Si(CH₃)₂—CH₂—CH₂—Si(OCH₃)₃. In these embodiments, subscript b is typically an independently selected integer from 17 to 25.

In another embodiment of the surface treatment composition in which Y in general formula (A) is F, as introduced above, Z in general formula (A) is —(CF(CF₃)CF₂O)—. In this embodiment, subscripts b, c, d, e and g in general formula (A) are 0, and subscripts f, h and n in general formula (A) are each independently an integer greater than 0. As but one example of this embodiment, subscripts b, c, d, e and g in general formula (A) are 0, subscript a′ is at least 1, subscript f is 1, subscript h is 1, X′ is an oxygen atom, subscript n is 3, and subscripts i, m and j are each 0. In this one example, the polyfluoropolyether silane has the following general formula: F—(CF(CF₃)—CF₂—O)_{a′}—CF(CF₃)—CH₂—O—CH₂—CH₂—CH₂—Si—(X″)_{3-z}(R²)_{z}. Thus, when the hydrolysable groups represented by X″ are all alkoxy groups, e.g. methoxy groups, and z is 0, this particular polyfluoropolyether silane has the following general formula: F—(CF(CF₃)—CF₂—O)_{a′}—CF(CF₃)—CH₂—O—CH₂—CH₂—CH₂—Si—(OCH₃)₃. Alternatively, when the hydrolysable groups represented by X″ are all alkylamino groups, e.g. N(CH₃)₂ groups, this particular polyfluoropolyether silane has the following general formula: F—(CF(CF₃)—CF₂—O)_{d}—CF(CF₃)—CH₂—O—CH₂—CH₂—CH₂—Si—(N(CH₃)₂)₃. In these embodiments, subscript a′ is typically an independently selected integer from 14 to 20.

In another embodiment of the surface treatment composition in which Y in general formula (A) is F and Z in general formula (A) is —(CF(CF₃)CF₂O)—, as introduced immediately above, subscripts b, c, d, e and g in general formula (A) are 0, subscript a′ is at least 1, subscript f is 1, subscript h is 1, X′ is an oxygen atom, subscript n is 3, subscript m and i are each 1, and subscript j is 2. In this one example, the polyfluoropolyether silane has the following general formula: F—(CF(CF₃)CF₂O)_{a′}—CF(CF₃)—CH₂—O—CH₂—CH₂—CH₂—Si(CH₃)₂—O—Si(CH₃)₂—CH₂—CH₂—Si—(X″)_{3-z}(R²)_{z}. Thus, when the hydrolysable groups represented by X″ are all alkoxy groups, e.g. methoxy groups, and z is 0, this particular polyfluoropolyether silane has the following general formula: F—(CF(CF₃)CF₂O)_{d}—CF(CF₃)—CH₂—O—CH₂—CH₂—CH₂—Si(CH₃)₂—O—Si(CH₃)₂—CH₂—CH₂—Si(OCH₃)₃. In these embodiments, subscript a′ is typically an independently selected integer from 14 to 20.

In other embodiments, Y in general formula (A) is Si—(X″)_{3-z}(R²)_{z}(CⱼH₂ⱼ)—((SiR¹₂—O)ₘ—SiR¹₂)ᵢ—(CₙH₂ⱼ)—X′—(CH₂)ₕ—. Typically, when Y in general formula (A) is Si—(X″)_{3-z}(R²)_{z}(CⱼH₂ⱼ)—((SiR¹₂—O)ₘ—SiR¹₂)ᵢ—(CₙH₂ₙ)—X′—(CH₂)ₕ—, subscripts b, c and f in general formula (A) are 0. As such, in these embodiments, when the groups represented by subscripts b, c and f are absent, the polyfluoropolyether silane has the following general formula: Y—Z_{a′}-[(OCF₂CF(CF₃))_{d}—(OC₂F₄)ₑ—(OCF₂)_{g}]—(CH₂)ₕ—X′—(CₙH₂ₙ)—((SiR¹₂—O)ₘ—SiR¹₂)ᵢ—(CᵢH₂ⱼ)—Si—(X″)_{3-z}(R²)_{z}.

In one embodiment in which Y in general formula (A) is Si—(X″)_{3-z}(R²)_{z}(CⱼH₂ⱼ)—((SiR¹₂—O)ₘ—SiR¹₂)ᵢ—(CₙH₂ₙ)—X′—(CH₂)ₕ—, as introduced immediately above, Z is (CF₂)—, X′ is an oxygen atom, subscripts b, c, d and f in general formula (A) are 0, and subscripts e and g in general formula (A) are each independently an integer greater than 0. As but one example of this embodiment, Z is (CF₂)—, X′ is an oxygen atom, subscripts b, c, d, f, m, i and j in general formula (A) are 0, subscript e is at least 1, subscript g is at least 1, subscript h is 1, X′ is an oxygen atom, and n is 3. In this one example, the polyfluoropolyether silane has the following general formula: (R²)_{z}(X″)_{3-z}Si—CH₂—CH₂—CH₂—O—CH₂—CF₂—(OCF₂CF₂)ₑ—(OCF₂)_{g}—CH₂—O—CH₂—CH₂—CH₂—Si—(X″)_{3-z}(R²)_{z}. Thus, when the hydrolysable groups represented by X″ are all alkoxy groups, e.g. methoxy groups, and z is 0, this particular polyfluoropolyether silane has the following general formula: (CH₃O)₃Si—CH₂—CH₂—CH₂—O—CH₂—CF₂—(OCF₂CF₂)ₑ—(OCF₂)_{g}—CH₂—O—CH₂—CH₂—CH₂—Si—(OCH₃)₃. Alternatively, when the hydrolysable groups represented by X″ are all alkylamino groups, e.g. N(CH₃)₂ groups, and z is 0, this particular polyfluoropolyether silane has the following general formula: ((CH₃)₂N)₃Si—CH₂—CH₂—CH₂—O—CH₂—CF₂—(OCF₂CF₂)ₑ—(OCF₂)_{g}—CH₂—O—CH₂—CH₂—CH₂—Si—(N(CH₃)₂)₃.

Alternatively, in another embodiment in which Y in general formula (A) is Si—(X″)_{3-z}(R²)_{z}(CₕH₂ⱼ)—((SiR¹₂—O)ₘ—SiR¹₂)ᵢ—(CₙH₂ₙ)—X′—(CH₂)ₕ—, as introduced above, Z is (CF₂)—, X′ is an oxygen atom, subscripts b, c, e and f in general formula (A) are 0, and subscripts d and g in general formula (A) are each independently an integer greater than 0.

The polyfluoropolyether silane may be obtained or formed and included in the composition as a discrete component, or the polyfluoropolyether silane may be disposed in a carrier solvent prior to incorporating the polyfluoropolyether silane and the carrier solvent in the composition. When the carrier solvent is utilized, the carrier solvent is typically selected from solvents disclosed below, although other solvents may alternatively be utilized.

The polyfluoropolyether silane is typically present in the composition in an amount of from 0.01 to 0.5, alternatively from 0.05 to 0.35, alternatively from 0.10 to 0.30, percent by weight based on the total weight of the composition. The amount of the solvent may vary from the ranges set forth immediately above contingent on the absence or presence of various optional components employed in the composition, as described in greater detail below.

The composition further comprises a solvent. The solvent of the composition may be any solvent capable of at least partially solubilizing the polyfluoropolyether silane. For example, the polyfluoropolyether silane may be added dropwise into a potential solvent to determine whether the potential solvent at least partially solubilizes the polyfluoropolyether silane by visual inspection. More specifically, the polyfluoropolyether silane generally disperses within the solvent, although the composition may be hazy or cloudy depending on how well the solvent solubilizes the polyfluoropolyether silane. The solvent is typically selected such that the solvent is non-reactive relative to the polyfluoropolyether silane. Specific examples of solvents suitable for the composition include perfluoroaliphatic C₅-C₁₂ hydrocarbons, such as perfluorohexane, perfluoromethylcyclohexane, and perfluoro-1,3-dimethylcyclohexane; polyfluorinated aromatic hydrocarbons such as bis(trifluoromethyl)benzene; polyfluorinated aliphatic hydrocarbons, perfluorobutyl methyl ether and like HFEs, perfluoropolyethers, perfluoroethers, nitrogen-containing perfluorinated or polyfluorinated solvents, etc. The composition may employ a single solvent or a combination of two or more solvents. Such solvents may be linear, branched, cyclic, aromatic, or may contain combinations thereof.

In certain embodiments, as set forth above, the solvent comprises a perfluoropolyether solvent. The perfluoropolyether solvent typically has a boiling point temperature of at least 40, alternatively at least 60, alternatively at least 80, alternatively at least 100, ° C. at atmospheric pressure. In one specific embodiment, the perfluoropolyether solvent has a boiling point temperature of from 125 to 145, alternatively from 130 to 140, ° C. at atmospheric pressure. In another specific embodiment, the perfluoropolyether solvent has a boiling point temperature of from 160 to 180, alternatively from 165 to 175, ° C. at atmospheric pressure. Typically, the boiling point temperature of the perfluoropolyether solvent is from greater than 120 to 180, alternatively from greater than 125 to 180, alternatively from greater than 160 to 180, ° C. at atmospheric pressure. However, the depending on the molecular weight of the perfluoropolyether solvent, the boiling point temperature of the perfluoropolyether solvent may be greater than the upper range of 180° C., e.g. to 200, 230, or 270° C.

In embodiments in which the solvent comprises the perfluoropolyether solvent, the solvent of the composition typically has the following general formula (B);

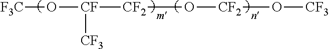

wherein m′ is an integer greater than 1 and n′ is 0 or greater Specifically, subscripts m′ and n′ of general formula (A) above are chosen so as to provide the desired boiling point temperature of the perfluoropolyether solvent. In particular, the relationship between subscripts m′ and n′, the boiling point temperature, and the molecular weight of the perfluoropolyether solvent is set forth below:

| Boiling Point (° C.) | Typical m′ | Typical n′ | Average MW (Da) |
|---|---|---|---|
| 125-145 | 1-3 | 1-7 | 600-620 |
| 160-180 | 1-4 | 1-10 | 750-770 |
| 190-210 | ≧1 | ≧1 | 860-880 |
| 220-240 | ≧1 | ≧1 | 1010-1030 |
| 260-280 | ≧1 | ≧1 | 1540-1560 |

Alternatively, as set forth above, the solvent may comprise a nitrogen-containing perfluorinated or polyfluorinated solvent. In these embodiments, the nitrogen-containing perfluorinated or polyfluorinated solvent is typically a tertiary amine in which the nitrogen atom is a center atom having three polyfluorinated or perfluorinated substituents, optionally including heteroatoms, such as oxygen. Typically, each of the substituents bonded to the nitrogen atom are identical, although these substituents may differ in terms of the number of carbon atoms present, the presence or absence of heteroatoms, and fluorine content. These substituents generally independently include from 2 to 10 carbon atoms, and are typically perfluorinated. As but one example of such a nitrogen-containing perfluorinated solvent, a structure representative of C₁₂F₂₇N is set forth below for illustrative purposes only:

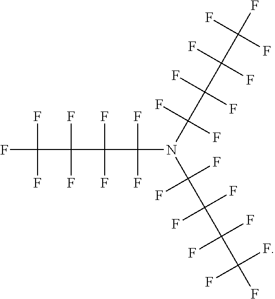 [SMILES: FC(F)(F)C(F)(F)C(F)(F)C(F)(F)N(C(F)(F)C(F)(F)C(F)(F)C(F)(F)F)C(F)(F)C(F)(F)C(F)(F)C(F)(F)F]

Typically, when the solvent comprises the nitrogen-containing perfluorinated or polyfluorinated solvent, the solvent comprises a combination of different nitrogen-containing perfluorinated or polyfluorinated solvents.

The solvent may comprise any combination of solvents, although such a combination typically includes the perfluoropolyether solvent and/or the nitrogen-containing perfluorinated solvent. For example, the perfluoropolyether solvent may be utilized in concert with the nitrogen-containing perfluorinated solvent. Alternatively, the perfluoropolyether solvent and/or the nitrogen-containing perfluorinated solvent may be utilized in combination with one another and/or with other solvents.

Regardless of the particular solvent employed in the composition, the solvent is typically present in the composition in an amount of from 95 to 99.99, alternatively from 97.35 to 99.95, alternatively from 99.7 to 99.9, percent by weight based on the total weight of the composition. The amount of the solvent may vary from the ranges set forth immediately above contingent on the absence or presence of various optional components employed in the composition, as described in greater detail below.

The composition may additionally include any suitable other component(s) such as a coupling agent, an antistatic agent, an ultraviolet absorber, a plasticizer, a leveling agent, a pigment, a catalyst, and so on.

Catalysts may optionally be utilized to promote surface modification by the composition. These catalysts promote the reaction between the hydrolysable groups of the polyfluoropolyether silane and the surface of the article. These catalysts can be used individually or as a combination of two or more in the composition. Examples of suitable catalytic compounds include acids, such as carboxylic acid, e.g. formic acid, acetic acid, propionic acid, butyric acid, and/or valeric acid; bases; metal salts of organic acids, such as dibutyl tin dioctoate, iron stearate, and/or lead octoate; titanate esters, such as tetraisopropyl titanate and/or tetrabutyl titanate; chelate compounds, such as acetylacetonato titanium; silazanes, such as hexamethyl disilazane and/or divinyltetramethyl disilazane; silanes, such as tetrakis(dimethylamine)silane and/or aminopropyltriethoxysilane, and the like. If utilized, the catalysts are typically utilized in an amount of from greater than 0 to 5, alternatively 0.01 to 2, percent by weight, based on 100 parts by weight of the composition.

The composition further comprises an additive compound for improving durability of layers formed from the composition. The additive compound is selected from a silane compound, a silyl amine compound, and combinations thereof.

The silane compound suitable for the additive compound has the following general formula:

RₐSiX₄₋ₐ

wherein each R is independently selected from a substituted or unsubstituted hydrocarbyl group and a nitrogen-containing substituent, with at least one R being a nitrogen-containing substituent, X is an independently selected hydrolysable group, and 1≦a<4.

The hydrolysable group represented by X of the silane compound is independently selected from a halide group, an alkoxy (—OR³) group, a carboxy (—OOC—R³) group, or an alkenyloxy (O—C(═CR³R⁴)R⁵) group, wherein R³, R⁴ and R⁵ are defined above relative to the hydrolysable group X″ of the polyfluoropolyether silane represented by general formula (A). Most typically, the hydrolysable group represented by X of the silane compound is independently selected from alkoxy groups, which may have a different number of carbon atoms represented by R³.

The nitrogen-containing substituent of the silane compound represented by R may be independently selected from an amino group, an alkylamino (—NHR³ or —NR³R⁴) group, an alkyliminoxy (—O—N═CR³R⁴) group, and an N-alkylamido (—NR³COR⁴) group. When the nitrogen-containing substituent of the additive compound is an alkylamino group, R³ and R⁴ optionally can form a cyclic amine in the alkylamino group. The nitrogen atom of the nitrogen-containing substituent may be bonded directly to the silicon atom of the silane compound, or the nitrogen atom may be bonded to the silicon atom of the silane compound by a divalent linking group, e.g. (CH₂)ₓ, which may optionally include heteroatom(s), e.g. oxygen.

As set forth above, 1≦a<4. As such, the silane compound necessarily includes at least one nitrogen-containing substituent. Most typically, subscript a is an integer from 1 to 3, alternatively from 1 to 2, alternatively 1. As such, because at least one R is the nitrogen-containing substituent, in embodiments in which subscript a is 1, the silane compound does not include a substituted or unsubstituted hydrocarbyl group (unless the nitrogen-containing substituent constitutes a substituted hydrocarbyl group).

Specific examples of silane compounds suitable for the additive compound of the composition include, but are not limited to, 3-aminopropyl trimethoxysilane, [3-(2-aminoethylamino)propyl]trimethoxy silane, 3-aminopropyltrimethoxy silane, and combinations thereof.

As set forth above, in other embodiments, the additive compound comprises a silyl amine compound. The silyl amine compound may include one or more silicon atoms and/or one or more nitrogen atoms. Most typically, however, the silyl amine compound does not include more than one silicon atom and more than one nitrogen simultaneously atom in one molecule, i.e., the silyl amine compound includes one silicon atom and two or more nitrogen atoms, or the silyl amine compound includes one nitrogen atom and two or more silicon atoms. In certain embodiments, the silyl amine compound includes a central silicon having from 2 to 4 nitrogen-based substituents, and in other embodiments, the silyl amine compound includes a central nitrogen atom having two to three silicon-based substituents. The silyl amine compound includes at least one, typically at least two, Si—N bonds. However, a single silicon atom may be bonded to two different nitrogen atoms to provide two Si—N bonds, or a single nitrogen atom.

To this end, the silyl amine compound may be referred to as a silazane compound, although not all silyl amine compounds include an Si—H bond, which is generally present in traditional silazanes compounds. The substituents of the silicon and nitrogen atoms of the silyl amine compound are typically selected from hydrogen and substituted or unsubstituted hydrocarbyl groups. Most typically, the substituents of the silicon and nitrogen atoms of the silyl amine compound are selected from nitrogen at C₁-C₄ hydrocarbon groups, which may optionally include one or more unsaturated carbon-carbon bonds.

Specific examples of silyl amine compounds suitable for the additive compound of the composition include tetrakis(dimethylamine)silane, tris(dimethylamine)methylsilane, bis(dimethylamine)dimethylsilane, bis[dimethyl(vinyl)silyl]amine, bis(trimethylsilyl)amine, tris(trimethylsilyl)amine, and combinations thereof.

Chemical structures of such silyl amine compounds are set forth below for illustrative purposes only and these chemical structures are not representative of all possible silyl amine compounds suitable for purposes of the additive compound; rather these are merely exemplary examples of silyl amine compounds:

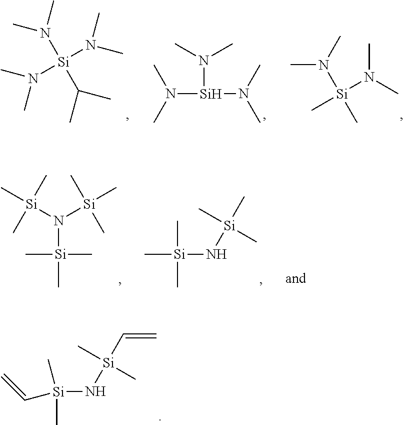

The additive compound may be obtained or formed and included in the composition as a discrete component, or the additive compound may be disposed in a carrier solvent prior to incorporating the additive compound and the carrier solvent in the composition. When the carrier solvent is utilized, the carrier solvent is typically selected from the solvents disclosed above, although other solvents may alternatively be utilized.

Regardless of the additive compound utilized in the composition, the additive compound is typically present in the composition in an amount of from greater than 0 to 0.1, alternatively from 0.00004 to 0.05976, alternatively from 0.003445 to 0.040035, percent by weight based on the total weight of the composition. The amount of the additive compound may vary from the ranges set forth immediately above contingent on the absence or presence of various optional components employed in the composition, as described in greater detail below.

The additive compound improves both the appearance and durability of layers formed form the composition.

As set forth above, the present invention further provides a surface-treated article and a method of preparing a surface-treated article, which are described collectively in greater detail below.

The surface-treated article comprises an article presenting a surface. A layer is deposited on the surface of the article. The layer is formed from the composition, which is applied on the surface of the article to prepare the surface-treated article. Although the article may be any article, because of the excellent physical properties obtained from the composition of the present invention, the article is typically an electronic article, an optical article, consumer appliances and components, automotive bodies and components, etc. Most typically, the article is an article for which it is desirable to reduce stains and/or smudges resulting from fingerprints or skin oils.

Examples of electronic articles typically include those having electronic displays, such as LCD displays, LED displays, OLED displays, plasma displays, etc. These electronic displays are often utilized in various electronic devices, such as computer monitors, televisions, smart phones, GPS units, music players, remote controls, portable readers, etc. Exemplary electronic articles include those having interactive touch-screen displays or other components which are often in contact with the skin and which oftentimes display stains and/or smudges.

As introduced above, the article may also be a metal article, such as consumer appliances and components. Exemplary articles are a dishwasher, a stove, a microwave, a refrigerator, a freezer, etc, typically having a glossy metal appearance, such as stainless steel, brushed nickel, etc.

Alternatively, the article may be an automotive body or component. For example, the composition may be applied directly on a top coat of an automobile body to form the layer, which imparts the automobile body with a glossy appearance, which is aesthetically pleasing and resists stains, such as dirt, etc., as well as smudges from fingerprints.

Examples of suitable optical articles include inorganic materials, such as glass plates, glass plates comprising an inorganic layer, ceramics, and the like. Additional examples of suitable optical articles include organic materials, such as transparent plastic materials and transparent plastic materials comprising an inorganic layer, etc. Specific examples of optical articles include antireflective films, optical filters, optical lenses, eyeglass lenses, beam splitters, prisms, mirrors, etc.

Examples of inorganic materials include glass plates. Examples of inorganic compounds for forming glass plates comprising an inorganic layer include metal oxides (silicon oxides, such as silicon dioxide, silicon monoxide, etc.), magnesium oxide, titanium oxide, tin oxide, zirconium oxide, sodium oxide, antimony oxide, indium oxide, bismuth oxide, yttrium oxide, cerium oxide, zinc oxide, ITO (indium tin oxide) and the like.

The inorganic layer or inorganic material comprising such an inorganic compound may be single- or multi-layered. The inorganic layer acts as an antireflective layer, and can be formed by known methods, such as wet coating methods. Examples of wet coating methods include dip coating, spin coating, flow coating, spray coating, roll coating, gravure coating, die coating, and like methods. Examples of PVD methods include vacuum evaporation, reactive deposition, ion beam assisted deposition, sputtering, ion plating, and like methods.

Among organic materials, examples of transparent plastic materials include materials comprising various organic polymers. From the view point of transparency, refractive index, dispersibility and like optical properties, and various other properties such as shock resistance, heat resistance and durability, materials used as optical members usually comprise polyolefins (polyethylene, polypropylene, etc.), polyesters (polyethylene terephthalate, polyethylene naphthalate, etc.), polyamides (nylon 6, nylon 66, etc.), polystyrene, polyvinyl chloride, polyimides, polyvinyl alcohol, ethylene vinyl alcohol, acrylics, celluloses (triacetylcellulose, diacetylcellulose, cellophane, etc.), or copolymers of such organic polymers. It is to be appreciated that these materials may be utilized in ophthalmic elements. Non-limiting examples of ophthalmic elements include corrective and non-corrective lenses, including single vision or multi-vision lenses like bifocal, trifocal and progressive lenses, which may be either segmented or non-segmented, as well as other elements used to correct, protect, or enhance vision, including without limitation contact lenses, intra-ocular lenses, magnifying lenses and protective lenses or visors. Preferred material for ophthalmic elements comprises one or more polymers selected from polycarbonates, polyamides, polyimides, polysulfones, polyethylene terephthalate and polycarbonate copolymers, polyolefins, especially polynorbornenes, diethylene glycol-bis(allyl carbonate) polymers—known as CR39—and copolymers, (meth)acrylic polymers and copolymers, especially (meth)acrylic polymers and copolymers derived from bisphenol A, thio(meth)acrylic polymers and copolymers, urethane and thiourethane polymers and copolymers, epoxy polymers and copolymers, and episulfide polymers and copolymers.

In addition to such optical articles, the composition of the invention can be applied to form the layer on other articles, such as window members for automobiles or airplanes, thus providing advanced functionality. To further improve surface hardness, it is also possible to perform surface modification by a so-called sol-gel process using a combination of the composition and TEOS (tetraethoxysilane).

One particular substrate of interest on which the composition may be applied to form the layer is Corning® Gorilla® Glass, commercially available from Corning Incorporated of Corning, N.Y.

The step of applying the composition on the surface of the article to form the layer typically comprises a wet coating method.

Specific examples of wet coating methods suitable for the method include dip coating, spin coating, flow coating, spray coating, roll coating, gravure coating, slot coating, and like methods.

Once the layer is formed on the surface of the article from the composition, the layer may further undergo heating, humidification, catalytic post treatment, photoirradiation, electron beam irradiation, etc.

Typically, the thickness of the layer formed from the composition is from 1-1,000, alternatively 1-200, alternatively 1-20, alternatively 1-10, nm.

As noted above, layers formed from the composition have a desirable appearance that is generally free from undesirable streaks, which are prevalent in layers formed from conventional surface treatment compositions. Layers formed from conventional compositions are generally washed and/or rinsed with a solvent, which may be the same as or different from the solvent employed in the conventional compositions, to minimize such streaking. However, such washing and/or rinsing generally adversely impacts abrasion resistance. In certain embodiments, the method of preparing the surface-treated article is free from the step of washing the layer on the surface of the article with a solvent, yet the layers formed from the inventive composition have a desirable appearance with excellent durability.

The appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The following examples are intended to illustrate the invention and are not to be viewed in any way as limiting to the scope of the invention.

### EXAMPLES

Compositions for surface treatment are prepared in accordance with the subject disclosure. In particular, each of the compositions described below comprises a solvent, an additive compound, and a polyfluoropolyether silane (save for Comparative Example 1, which does not include such an additive compound). Unless otherwise indicated, any percentages set forth below relate to weight percentages.

### Practical Example 1

TABLE 1
Practical Example 1

| Component | Amount |
|---|---|
| Polyfluoropolyether Silane 1 | 0.19582 |
| Additive Compound 1 | 0.19582 |
| Carrier Solvent | 0.00677 |
| Solvent 1 | 99.60159 |

Polyfluoropolyether Silane 1 has the following general formula: F—(CF(CF₃)CF₂O)ₐCF(CF₃)—CH₂—O—CH₂—CH₂—CH₂—Si(CH₃)₂—O—Si(CH₃)₂—CH₂—CH₂—Si(OCH₃)₃, where a′ is an integer from 14 to 20.

Additive compound 1 is a silyl amine compound comprising tetrakis(dimethylaminosilane).

Carrier solvent is ethoxy-nonafluorobutane (C₄F₉OC₂H₅).

Solvent 1 is a perfluoropolyether solvent having a boiling point temperature of about 170° C. at atmospheric pressure and having the following general formula:

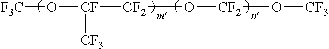

wherein m′ is an integer ≧1 and n′ is ≧0 so as to provide an average molecular weight of about 760 Da.

### Practical Example 2

TABLE 2
Practical Example 2

| Component | Amount |
|---|---|
| Polyfluoropolyether Silane 1 | 0.19582 |
| Additive Compound 2 | 0.19582 |
| Carrier Solvent | 0.00677 |
| Solvent 1 | 99.60159 |

Additive Compound 2 is a silyl amine compound comprising bis[dimethyl(vinyl)silyl)amine.

### Practical Example 3

TABLE 3
Practical Example 3

| Component | Amount |
|---|---|
| Polyfluoropolyether Silane 1 | 0.19582 |
| Additive Compound 3 | 0.19582 |
| Carrier Solvent | 0.00677 |
| Solvent 1 | 99.60159 |

Additive Compound 3 is a silane compound comprising aminopropyl triethoxysilane.

### Comparative Example 1

TABLE 4
Comparative Example 1

| Component | Amount |
|---|---|
| Polyfluoropolyether Silane 1 | 0.2 |
| Solvent 1 | 99.8 |

The compositions of Practical Examples 1-3 and Comparative Example 1 are each applied to a surface of a substrate. In particular, these compositions are applied to a glass substrate via a PVA-1000 dispensing machine having an atomization pressure of 1 psi, a liquid pressure of from 5 psi, a stroke 2.5 mil, a nozzle height of from 5.3 cm, and a speed of about 20,000 counts/sec. Once the respective compositions were applied to the substrates, the compositions were cured at room temperature for about 24 hours to form layers on the substrates.

Physical properties of the layers formed from the compositions are measured. In particular, the water contact angle and abrasion resistance of each of the layers is measured, as described in greater detail below.

The abrasion resistance, i.e., durability, of the layers is determined via an abrasion resistance test that utilizes a reciprocating abraser—Model 5900, which is commercially available from Taber Industries. The abrading material utilized was a rubbing eraser having dimensions of 6.5 mm×12.2 mm. The reciprocating abraser is operated for 1500 cycles at a speed of 40 cycles per minute with a stroke length of 1 inch and a load of 5 N.

The water contact angle (WCA) of each of the layers is measured via a VCA Optima XE goniometer, which is commercially available from AST Products, Inc., Billerica, Mass. The water contact angle measured is a static contact angle based on a 2 μL droplet on each of the layers. The water contact angle is measured before and after the abrasion resistance test.

TABLE 5

WCA

| Example: | Initial | Final |
|---|---|---|
| Practical Example 1 | 115.1 | 102.8 |
| Practical Example 2 | 114.5 | 106.3 |
| Practical Example 3 | 116.4 | 102.0 |
| Comparative Example 1 | 116.5 | 53.9 |

As clearly illustrated above in Table 5, the WCA after the abrasion resistance test was substantially maintained for each of the layers of Practical Examples 1-3, particularly as compared to the layer of Comparative Example 1, which did not include the additive compound. For example, the lowest final WCA for any of the layers of Practical Examples relative to the initial WCA of these layers was in Practical Example 3, in which the final WCA was about 87.6 percent of the initial WCA (with this value being about 89.3 percent for Practical Example 1 and about 92.8 percent for Practical Example 2). Conversely, however, the final WCA for the layer of Comparative Example 1 was a mere 46.3 percent of the initial WCA, which is attributable to the absence of the instant additive compound.

The invention has been described in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described.

1. A composition for surface treatment comprising:
a polyfluoropolyether silane;
a solvent; and
an additive compound selected from:
a silane compound having the following general formula:
RₐSiX₄₋ₐ;
wherein each R is independently selected from a substituted or unsubstituted hydrocarbyl group and a nitrogen-containing substituent, with at least one R being a nitrogen-containing substituent, X is an independently selected hydrolysable group, and 1≦a<4;
a silyl amine compound; and
combinations thereof.

2. The composition of claim 1 wherein said polyfluoropolyether silane has the following general formula (A):
Y—Z_{a′}-[(OC₃F₆)_{b}—(OCF(CF₃)CF₂)_{c}—(OCF₂CF(CF₃))_{d}—(OC₂F₄)ₑ—(CF(CF₃))_{f}—(OCF₂)_{g}]—(CH₂)ₕ—X′—(CₙH₂ₙ)—((SiR¹₂—O)ₘ—SiR¹₂)ᵢ—(CⱼH₂ⱼ)—Si(X″)_{3-z}(R²)_{z};
wherein Z is independently selected from —(CF₂)—, —(CF(CF₃)CF₂O)—, —(CF₂CF(CF₃)O)—, —(CF(CF₃)O)—, —(CF(CF₃)CF₂)—, —(CF₂CF(CF₃))—, and —(CF(CF₃))—; a′ is an integer from 1 to 200; b, c, d, e, f, and g are integers each independently selected from 0 to 200; h, n and j are integers each independently selected from 0 to 20; i and m are integers each independently selected from 0 to 5; X′ is a bivalent organic group or an oxygen atom; R¹ is an independently selected C₁-C₂₂ hydrocarbon group; z is an integer independently selected from 0 to 2; X″ is an independently selected hydrolysable group; R² is an independently selected C₁-C₂₂ hydrocarbon group which is free of aliphatic unsaturation; and Y is selected from F and Si—(X″)_{3-z}(R²)_{z}(CⱼH₂ⱼ)—((SiR¹₂—O)ₘ—SiR¹₂)ᵢ—(CₙH₂ₙ)—X′—(CH₂)ₕ—; wherein X″, X′, z, R¹, R², j, m, i, n and h are as defined above;
provided that when subscript i is 0, subscript j is also 0; when subscript i is an integer greater than 0, subscript j is also an integer greater than 0; and when subscript i is an integer greater than 0, m is also an integer greater than 0.

3. The composition of claim 2 wherein said hydrolysable group represented by X″ in general formula (A) of said polyfluoropolyether silane is independently selected from a halide group, —OR³, —NHR³, —NR³R⁴, —OOC—R³, —O—N═CR³R⁴, —O—C(═CR³R⁴)R⁵, and —NR³COR⁴, wherein R³, R⁴ and R⁵ are each independently selected from H and a C₁-C₂₂ hydrocarbon group, and wherein R³ and R⁴ optionally can form a cyclic amine in the alkylamino group.

4. The composition of claim 1 wherein said perfluoropolyether solvent is present in said surface treatment composition in an amount of from 95 to 99.99 percent by weight based on the total weight of said surface treatment composition, said polyfluoropolyether silane is present in said surface treatment composition in an amount of from 0.01 to 0.5 percent by weight based on the total weight of said surface treatment composition, and said additive compound is present in said surface treatment composition in an amount of from 0.00004 to 0.06 percent by weight based on the total weight of said surface treatment composition.

5. The composition of claim 1 wherein said additive compound comprises said silane compound and wherein subscript a is 1, X is an independently selected alkoxy group, and R comprises an amino group.

6. The composition of claim 1 wherein said additive compound comprises said silyl amine compound with said silyl amine compound being selected from the group of tetrakis(dimethylamine)silane, tris(dimethylamine)methylsilane, bis(dimethylamine)dimethylsilane, bis[dimethyl(vinyl)silyl]amine, bis(trimethylsilyl)amine, tris(trimethylsilyl)amine, and combinations thereof.

7. A method of preparing a surface-treated article, said method comprising applying a composition for surface treatment on a surface of an article to form a layer on the surface of the article from the composition; wherein the composition comprises;
a polyfluoropolyether silane;
a solvent; and
an additive compound selected from:
a silane compound having the following general formula:
RₐSiX₄₋ₐ;
wherein each R is independently selected from a substituted or unsubstituted hydrocarbyl group and a nitrogen-containing substituent, with at least one R being a nitrogen-containing substituent, X is an independently selected hydrolysable group, and 1≦a<4;
a silyl amine compound; and
combinations thereof.

8. The method of claim 7 wherein the perfluoropolyether silane has the following general formula (A):
Y—Z_{a′}-[(OC₃F₆)_{b}—(OCF(CF₃)CF₂)_{c}—(OCF₂CF(CF₃))_{d}—(OC₂F₄)ₑ—(CF(CF₃))_{f}—(OCF₂)_{g}]—(CH₂)ₕ—X′—(CₙH₂ₙ)—((SiR¹₂—O)ₘ—SiR¹₂)ᵢ—(CⱼH₂ⱼ)—Si—(X″)_{3-z}(R²)_{z};
wherein Z is independently selected from —(CF₂)—, —(CF(CF₃)CF₂O)—, —(CF₂CF(CF₃)O)—, —(CF(CF₃)O)—, —(CF(CF₃)CF₂)—, —(CF₂CF(CF₃))—, and —(CF(CF₃))—; a′ is an integer from 1 to 200; b, c, d, e, f, and g are integers each independently selected from 0 to 200; h, n and j are integers each independently selected from 0 to 20; i and m are integers each independently selected from 0 to 5; X′ is a bivalent organic group or an oxygen atom; R¹ is an independently selected C₁-C₂₂ hydrocarbon group; z is an integer independently selected from 0 to 2; X″ is an independently selected hydrolysable group; R² is an independently selected C₁-C₂₂ hydrocarbon group which is free of aliphatic unsaturation; and Y is selected from F and Si—(X″)_{3-z}(R²)_{z}(CⱼH₂ⱼ)—((SiR¹₂—O)ₘ—SiR¹₂)ᵢ—(CₙH₂ₙ)—X′—(CH₂)ₕ—; wherein X″, X′, z, R¹, R², j, m, i, n and h are as defined above;
provided that when subscript i is 0, subscript j is also 0; when subscript i is an integer greater than 0, subscript j is also an integer greater than 0; and when subscript i is an integer greater than 0, m is also an integer greater than 0.

9. The method of claim 7 free from the step of washing the layer on the surface of the article with a solvent.

10. The method of claim 7 wherein the step of applying the composition is selected from dip coating, spin coating, flow coating, spray coating, roll coating, gravure coating, vacuum evaporation, physical vapor deposition, sputtering, chemical vapor deposition, atmospheric pressure plasma, and combinations thereof.

11. The method of claim 8 wherein the hydrolysable group represented by X″ in general formula (A) of the polyfluoropolyether silane is independently selected from a halide group, —OR³, —NHR³, —NR³R⁴, —OOC—R³, —O—N═CR³R⁴, —O—C(═CR³R⁴)R⁵, and —NR³COR⁴, wherein R³, R⁴ and R⁵ are each independently selected from H and a C₁-C₂₂ hydrocarbon group, and wherein R³ and R⁴ optionally can form a cyclic amine in the alkylamino group.

12. The method of claim 7 wherein the perfluoropolyether solvent is present in the composition in an amount of from 95 to 99.99 percent by weight based on the total weight of the surface treatment composition, the polyfluoropolyether silane is present in the surface treatment composition in an amount of from 0.01 to 0.5 percent by weight based on the total weight of the surface treatment composition, and the additive compound is present in the surface treatment composition in an amount of from 0.00004 to 0.06 percent by weight based on the total weight of the surface treatment composition.

13. The method of claim 7 wherein the additive compound comprises the silane compound and wherein subscript a is 1, X is an independently selected alkoxy group, and R comprises an amino group.

14. The method of claim 7 wherein the additive compound comprises the silyl amine compound with the silyl amine compound being selected from the group of tetrakis(dimethylamine)silane, tris(dimethylamine)methylsilane, bis(dimethylamine)dimethylsilane, bis[dimethyl(vinyl)silyl]amine, bis(trimethylsilyl)amine, tris(trimethylsilyl)amine, and combinations thereof.

15. A surface treated article formed in accordance with the method of claim 7.
